(19) United States
(12) Patent Application Publication
(10) Pub. No.: US 2007/0065556 A1
(43) Pub. Date: Mar. 22, 2007

(54) Nutritional food products employing gelled protein formulations

(76) Inventor: Robert W. Martin JR., San Ramon, CA (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 11/230,782

(22) Filed: Sep. 20, 2005

(51) Int. Cl. A23G 9/00

(52) U.S. Cl. 426/565

(57) ABSTRACT

This invention relates to nutritional food products having palatable/organoleptic characteristics. The palatable/organoleptic characteristics are obtained in part through use of gelled whey protein, soy protein and egg protein containing formulations. Such nutritional food products include powders, liquids and, especially, frozen foods such as frozen nutrition bars and cones. Methods for making such products are also disclosed.

### BACKGROUND OF THE INVENTION

This invention generally relates to nutritional food products. For purposes of this patent disclosure, the term(s) “nutritional food product(s)” can be taken to imply the significant presence of certain hereinafter more fully described protein-containing ingredients in those nutritional food products. This invention is also especially concerned with frozen nutritional snack food products such as frozen bars, cones, cups and the like, as well as methods for producing such products.

Nutritional food products usually employ one or more protein-containing ingredients. For example, many nutritional food products such as those protein powders used by athletes, health food enthusiasts, dieters and people with certain medical concerns (e.g., people that are lactose intolerant, diabetic, otherwise allergic to dairy products, etc.) have employed whey protein (e.g., whey isolate and/or whey concentrate), soy protein (e.g., soy isolate and/or soy concentrate) and egg protein (e.g., egg white-derived protein materials) as sources of those amino acids that are vital to human nutrition and/or, in certain cases, medical wellbeing.

In and of themselves, most protein-containing ingredients of the types just noted are not well regarded in terms of their abilities to impart generally desirable tastes to most human beings. Indeed, these undesirable taste attributes have persistently stymied many attempts to introduce such protein-containing ingredients into so-called “pleasure foods” e.g., dairy foods whose primary consideration is good taste—as opposed to high nutritional value. For example, many attempts have been made to develop protein-containing ice cream products that retain their desirable ice cream taste, but which also have improved nutritional properties. Unfortunately, such protein-modified ice creams have had to greatly sacrifice their desirable tastes for their improved nutritional properties. Indeed, the degree of unpleasant taste of many protein-containing ingredients often, in a qualitative sense, goes beyond the relative concentrations of these protein ingredients in many pleasure foods. That is to say that just a little protein ingredient can go a long way toward persistently degrading the taste of most ice cream products.

Moreover, many past attempts to increase the sweetness of protein-containing pleasure foods in order to offset the unappetizing flavors of their protein-containing ingredients have not been particularly successful; hence, many protein-containing pleasure food products have not been well received by the general consuming public. In other words, those skilled in the food processing arts have come to appreciate that simply adding more and more sweeteners to compensate for the off flavors resulting from the use of more and more protein ingredients in such pleasure foods often results in an over-sweetening that tends to overpower and/or cloy many human tastes—while still failing to overcome many persistent, unappetizing protein tastes. Indeed, many protein ingredient off flavors tend to linger well beyond certain sweet sensations no matter how much sweetener is employed in a pleasure food. The additional use of other flavoring agents (vanilla, chocolate, strawberry, etc.) has not solved these taste problems either. Thus, it might be said that the unpalatable characteristics, and resistance to masking, of protein-containing ingredients such as whey, soy and egg have proven to be highly problematic, and in many cases intractable, in a wide variety of dairy type pleasure foods.

Past efforts to produce frozen nutritional food products that do not contain dairy products have not fared any better. That is to say that many non-dairy frozen nutritional food products have been equally hampered by the unmaskable, disagreeable tastes of their protein-containing ingredients. The patent literature clearly reflects these palatability problems with respect to both frozen nutritional dairy products and frozen nutritional non-dairy products. For example, U.S. Patent Application Publication No. 2003/0031758 teaches methods for preparing various palatable nutritional frozen desserts. These desserts generally comprise: a base component, a non-fruit flavoring agent and a nutrient core of at least 1% by weight of the dessert product. Sweeteners and an acidulant are also liberally employed in these products.

The preferred method for making these frozen dessert products begins with mixing: (a) a base component, (b) a nutrient core including at least one micronutrient selected from the group consisting of: folate, folic acid, magnesium, phosphorus, zinc, selenium, iron, copper, chromium, molybdenum, iodine, potassium, sodium, Vitamin A, Vitamin C, Vitamin D, Vitamin B1, Vitamin B2, Vitamin B3, Vitamin B5, Vitamin B6, Vitamin B12, Vitamin E, Vitamin K, biotin, manganese, and combinations thereof and (c) an acidulant. These mixtures are then pasteurized and homogenized. The resulting material is then frozen to produce a final frozen dessert product.

U.S. Patent Application Publication No. 2004/0018277 teaches methods for preparing frozen food products comprising a gelled aqueous phase. These methods comprise: (1) a mixing step A which consists of mixing all of the product's ingredients except for the gelling compound(s), (2) a mixing step B which consists in preparing a solution of gelling compounds, (3) dynamically mixing the compounds resulting from steps A and B and finally (4) freezing the resulting mixed product. The invention also concerns certain frozen food products, in particular iced food products, obtainable by the disclosed method. Such frozen food products are presented to the consumer in the form of a soft, gelled, stable and homogeneous aqueous phase.

U.S. Pat. No. 6,558,731 teaches a frozen food with a high protein to fat ratio. This frozen food also can be prepared with a low sugar content and a high protein to sugar and a high protein to fat ratio. A major portion of the protein is derived from water soluble, whey protein. For example, a preferred formulation of this food is comprised of: (a) 11% to about 25% by weight of a water soluble protein such as a whey protein concentrate (e.g., Power Pro®, whey protein-containing products of Land O'Lakes Corporation), (b) about 0.2% to about 15% by weight of at least one natural or artificial flavor, (c) about 6% to about 14% by weight of bulking and/or sweetening agents, (d) about 0.1 to about 2.0% by weight of microcrystalline cellulose, (e) about 0.1% to about 2.0% by weight of pectin and (f) a remainder mostly comprised of water, (g) optionally, up to about 2.0% by weight of stabilizer and (h) optionally, up to about 0.25% by weight of an acidulant.

U.S. Pat. No. 4,021,583 discloses a method of making a quiescently frozen confection comprising the steps of mixing together water, pureed fruit and sweetener, to produce a solution in which said pureed fruit constitutes from about 10 to 40 weight percent of said solution. The sweetener constitutes from about 8 to 20 weight percent of said solution. Water is added in an amount such that the resulting solution has a total solids content of about 21 to 25 weight percent. The solution is then poured into molds, and quiescently frozen in said molds with a 0 to 10 percent overrun to produce the finished frozen product.

U.S. Pat. No. 3,274,958 teaches a method of making an ice cream stick having a candy core. The method generally comprises placing ice cream, in liquid form, in a mold. At least some of the ice cream in an outer region of said mold is converted to a solid form while maintaining the ice cream in the center region of the mold in a liquid form. A nozzle is inserted into and substantially to the bottom of the center region. A candy, in liquid form, is then injected through the nozzle to displace at least a part of the ice cream remaining in liquid form in the center region. The liquid candy and that part of the ice cream remaining in liquid form constitute a liquid handle-means receiver. The nozzle is withdrawn upwardly from the center region at a rate substantially equal to the rate of filling thereof by the liquid candy. A handle is inserted into said liquid handle receiver. The liquid handle-means receiver is then converted to a solid form.

U.S. Pat. No. 4,500,553 discloses a method for making a frozen, dual-textured confection comprising a cream and gelatin-containing aerated phase and a fruit phase. The method comprises the steps of: (a) dispersing a gelatin in water, (b) combining the gelatin dispersion with cream, milk solids, an emulsifier, a sweetener, and a gum stabilizer and homogenizing the combination to form a uniform emulsion having a gelatin content of from 0.8% to 2.5% by weight, (c) passing the emulsion of (b) through a freezer in which the emulsion is simultaneously cooled, aerated and agitated to produce a partially frozen, aerated composition having ice crystals within the range of 10 to 150 microns and an overrun from 5% to 300%, (d) combining pureed fruit and/or synthetic fruit flavor, water, a sweetener and a gum stabilizer to form a fluid, fruit phase component having a solids content between about 20% to 40% by weight, (e) passing the partially-frozen, aerated composition from (c) together with a fruit component of (d) through a filler head and into a mold or container at a ratio of from 99:1 to 1:1 by weight so that upon filling, the mold or container contains a cream and gelatin-containing phase and a fruit phase and (f) thoroughly freezing the contents of the mold or container.

U.S. Pat. No. 5,017,390 teaches a texturally contrasting frozen confection product, comprising: (a) a chilled material selected from the group consisting of ice confection and chilled mousse material and (b) at least one particle of an aerated, fat-based glaze material having a cellular structure and an overrun of at least 50%, the smallest dimension of said at least one particle being in excess of 1.5 mm.

U.S. Pat. No. 5,374,436 discloses a method for making a frozen confection having a plurality of differently flavored or colored sections. After partially freezing the ingredients in a mold for a first flavor or color to form a frozen outer layer and a liquid inner core, the liquid inner core is vacuumed from the mold. A carving tool, such as a laser, is then inserted into the area of the mold previously occupied by the liquid inner core. The carving tool removes a portion of the frozen outer layer in accordance with a predetermined pattern. The ingredients for a second flavor or color then are inserted into the mold to fill the inner core. Areas of the outer layer are removed with the carving tool. The mold is then subjected to freezing to form the final product.

U.S. Pat. No. 5,582,856 teaches a method for making a frozen confection having a plurality of differently flavored or colored sections. After creating, in a mold, a frozen outer layer comprising the ingredients for a first flavor or color, a carving means, such as a heated tool or a nozzle ejecting high-pressure gas, removes a portion of the frozen outer layer in accordance with a predetermined pattern. The ingredients for a second flavor or color then are added, and the mold is subjected to freezing to form the final product. Alternatively, a tool having protrusions contacting portions of the inner surface of the mold is inserted into the mold, before or after insertion of the first ingredients, the first ingredients are frozen, the tool is removed, and the second ingredients are then added and frozen. In another embodiment, a first flavor or color is sprayed onto the inner wall of the mold in a pattern and frozen. A second flavor or color then is added to the mold in liquid form and frozen to form a multi-flavor or multi-colored frozen confection.

U.S. Pat. No. 6,187,365 teaches a process for the production of a molded aerated frozen bar comprising the steps of preparing a mix of ingredients suitable for preparing a frozen aerated bar, whipping the mix to obtain an aerated mix having an overrun of between about 20% to about 250%, molding the aerated mix to give a molded aerated mix, and freezing the molded aerated mix to form the molded aerated frozen bar.

U.S. Pat. No. 6,284,294 discloses a patterned composite food product comprising an ice confectionary composition component and an edible inclusion material component which differs from the ice confectionery composition wherein the product has a pattern form comprised of a plurality of planar inclusion material layers separated one from another and completely surrounded by the ice confectionery composition and wherein the inclusion material layers consist essentially of a material selected from the group consisting of a fat-based composition, a water-based composition and a sugar syrup composition.

U.S. Pat. No. 6,093,438 teaches a process for the production of a molded aerated frozen bar by preparing a mix of ingredients suitable for a frozen aerated bar, whipping the mix to obtain an aerated mix having an overrun of from between about 20% to about 250%, molding the aerated mix to give a molded aerated mix and freezing the molded aerated mix to produce the molded frozen aerated bar.

U.S. Patent Application Publication No. 2002/01644403 teaches a frozen dessert novelty which is a water ice molded confection product that includes a thin translucent shell and a multi-colored core which is encased into the shell and which is visible in the product before and during consumption, and a process for preparing it. The product is mounted on a stick to facilitate handling and eating.

U.S. Patent Application Publication No. 2003/0147995 teaches a nutritious frozen dessert comprising: a base component, a nutrient core of at least 1% by weight of the dessert product and wherein the nutrient core includes at least one micronutrient selected from the group consisting of: folate, magnesium, phosphorus, zinc, selenium, iron, copper, chromium, molybdenum, manganese, iodine, potassium, sodium, Vitamin A, Vitamin C, Vitamin D, Vitamin B1, Vitamin B2, Vitamin B3, Vitamin B5, Vitamin B6, Vitamin B12, Vitamin E, Vitamin K, biotin, choline, chloride, vanadium, boron and combinations thereof; and a sweetener including greater than 25% by weight of the total sugar added of a high freezing point depression sweetener.

U.S. Pat. No. 6,821,544 relates to a method of molding a cheese or milk product, wherein the method comprises: (a) casting a melt of said product into at least one mold; (b) cooling to cause at least a peripheral layer of the melt to congeal; (c) reheating the mold(s) to soften a surface region of said peripheral layer; and (d) unmolding the product.

U.S. Pat. No. 6,713,101 discloses a frozen dessert novelty which is a water ice molded confection product that includes a thin translucent shell and a multi-colored core which is encased into the shell and which is visible in the product before and during consumption, and a process for preparing it. The product is mounted on a stick to facilitate handling and eating.

All references, patents and patent publications recited in the present patent application are hereby incorporated by reference, in their entirety, into this patent disclosure.

### SUMMARY OF THE INVENTION

The present invention is generally concerned with nutritional food products that contain multiple protein-containing ingredients such as whey protein isolate, whey protein concentrate, whole soybean powder, soy protein isolate, soy protein concentrate, egg protein, rice protein, caseinate (e.g., sodium caseinate, calcium caseinate and potassium caseinate), as well as vegetable proteins. This invention is, however, especially concerned with nutritional food products that contain whey protein (e.g., whey protein isolate and/or whey protein concentrate), soy protein (e.g., whole soybean powder, soy protein isolate and/or soy protein concentrate) and egg protein (e.g., protein derived from egg whites). Regardless of the exact identity of their protein-containing ingredients, the nutritional food products of this patent disclosure will include, but not be limited to: (1) powdered food products such as powdered nutrient blends, (2) aggregate solid food products such as nutrition bars, (3) liquid food products such as sports drinks (e.g., refrigerated or non-refrigerated shelf stable drinks) and, especially, (4) frozen snack food products such as bars, cups, cones, sandwiches, frozen milkshakes and fortified dairy products.

In any case, whatever their physical forms, the nutritional food products of this patent disclosure are particularly characterized by their improved taste characteristics. That is to say that all such products, regardless of their final physical form, are prepared with a view toward improving their palatable/organoleptic characteristics relative to those products which are not made through use of the protein-containing ingredients, concentrations and production methods of this patent disclosure. In effect, the ingredients, concentrations and production methods of this invention allow for the inclusion of the above noted protein-containing ingredients in nutritional food products—without simply giving up on taste considerations in the products in which they are employed and/or without completely resorting to the use of sweeteners and/or flavoring agents to try to hide the otherwise disagreeable flavors of many protein-containing ingredients.

Next, it might be noted here that those skilled in the food processing arts will appreciate that various methods for determining the general palatability of a given food product are well known. Some of these methods assess flavor while others assess odor. These methods often involve the use of taste panels of carefully selected human beings. Involved tasting protocols are usually employed in these taste panel tests. Taste acceptance considerations can also be important factors in marketing tests directed at the general consuming public. Various chemical assays for measuring and comparing the taste and odor of different compounds are also known, see for example U.S. Pat. No. 5,482,855.

Be these taste testing methods as they may, applicant has discovered that nutritional food products that are based upon certain multiple protein source formulations (e.g., formulations having at least three distinct protein-containing ingredients that, in total, constitute from about 1.0 to about 30.0 relative weight percent of a final nutritional food product) make relatively more palatable protein-containing products while still supplying a wide array of amino acids. Moreover, applicant has discovered that certain liquid or frozen protein formulations comprising: (1) whey protein (in isolate and/or concentrate forms) in concentrations of about 1 to about 20 weight percent of a final liquid or frozen product, (2) soy protein (e.g., in whole soybean powder, soy isolate and/or soy concentrate forms) in concentrations of about 0.5 to about 5.0 weight percent of said final liquid or frozen product and (3) egg protein in concentrations of about 0.5 to about 5.0 weight percent of such a final product, make much more palatable/organoleptic nutritional food products.

Next, it should be noted that applicant's frozen, powdered, solid and liquid final products will often have ingredients (e.g., water, sweeteners, stabilizers, nutrients, etc.) other than its protein-containing ingredients. Therefore, the dry weight percentages of the protein-containing ingredients relative to all ingredients in a final product will be used in this patent disclosure—unless otherwise stated. These protein ingredient dry weight percentages do, however, also imply certain relative weight percentages of each protein-containing ingredient relative to the other protein-containing ingredients. Thus, in the case of applicant's powdered nutritional food products, even though the three protein-containing ingredients may constitute up to virtually 100% of a final powdered product, they, nonetheless, should be used in the relative concentrations represented by 1-20% whey, 0.5-5.0 soy and 0.5-5.0 egg white concentrations used in describing the weight percentages of these ingredients in a final liquid, solid or frozen product. For example, in a powdered protein formulation whose relative concentrations were 20% (by weight) whey, 5% (by weight) soy and 5% (by weight) egg white when these ingredients were originally mixed in water, the whey ingredient would constitute 66.66% (20/20+5+5) of the final powdered product i.e., after the water was driven off to create the powdered form of the product. This all goes to say that a term like “relative weight percent” can be used to describe both a product having no other ingredients (e.g., a powder) or a product having other ingredients (e.g., the water in a frozen bar, liquid drink, candy bar and the like).

In any case, no matter what form the final product takes (e.g., frozen bar, liquid, solid, powder, etc.), applicant has found that if these multiple protein-containing ingredients, used in the concentrations noted herein, are at least partially gelled during an early stage of a given product's manufacturing process, the final nutritional food product (as opposed to a final product wherein ungelled forms of the otherwise same protein ingredients are merely mixed in their dry powder or dry flake forms, or merely mixed with water or other liquid without undergoing certain minimal gelling actions hereinafter more fully described) will have significantly improved tastes.

For the purposes of this patent disclosure the term “early stage” of a product's manufacturing process can be taken to mean, respectively: (1) before a gelled protein formulation is dried to produce a powdered final product, (2) before a gelled protein formulation is introduced into a carrier liquid (e.g., water, fruit juice, etc.) to produce a liquid final product, (3) before a gelled protein formulation is introduced into a solid-forming formulation (e.g., one having the final form of say a candy bar made from aggregated solid ingredients and relatively minor amounts of liquids) and (4) before a gelled protein formulation is converted into a frozen form such as a frozen pleasure food type bar. That is to say that applicant has discovered, quite unexpectedly, that a gelling of the protein-contain ingredients of the nutritional food products of this patent disclosure has a sensible impact on the palatable/organoleptic properties (e.g., a human taste sensible lessening of unappetizing flavors, including, but not limited to, bitter, metallic, and sour flavors that are usually imparted by flake or powdered forms of whey, soy and egg protein products) of applicant's resultant nutritional food products. Stated another way, the nutritional food products of this patent disclosure taste better if they are derived from a gelled formulation of applicant's protein-containing ingredients (as well as any other ingredients present in such a gelled formulation).

Those skilled in the food processing arts will appreciate that a gel is a colloidal dispersion (often, inaccurately, referred to as a “sol”) in which a disperse phase material (e.g., applicant's protein-containing whey, soy and egg white ingredients) is combined with a continuous phase material (e.g., applicant's water ingredient) to produce a colloidal dispersion. Depending on protein ingredient identities, concentrations, water temperature, process times, etc., the protein molecules of gel-forming ingredients entangle and crosslink (especially as an originally warm water in which the protein-containing ingredients are placed cools down). This results in a protein matrix whose interstices can retain a great deal of water.

The degree to which such protein-containing ingredients undergo a gel reaction can be controlled and measured in various ways known to those skilled in the food processing arts. For example, the ingredient concentrations, temperature and process times can be used to control the degree of gelling of a given protein formulation. This degree of gelling actions, in turn, can be determined by, for example, measuring the viscosity of a protein/water dispersion. It might also should be noted here that applicant's use of the words “gel,” “gelled,” etc. does not imply the production of a “solid” gel material in applicant's gelling step. Indeed, the production of such solid gels, such as those that characterize JELL-O® products, is better avoided in the practice of this invention.

Those skilled in the food processing arts also will appreciate that the term “viscosity” is used as a measure of the internal resistance to flow exhibited by a given fluid. For example, a liquid has a viscosity of one poise if a force of one dyne per square centimeter causes two parallel liquid surfaces one square centimeter in area and one centimeter apart to move past one another at a velocity of one centimeter per second. Water is the primary viscosity standard; it has a viscosity of 0.01002 poise (cps) at 20° C. Various devices and/or procedures are known for measuring a liquid's viscosity. For example, Brookfield Engineering Laboratories, Inc. makes a line of viscometers/rheometers commonly referred to as Brookfield spindles which are widely used in the food processing industry.

In any case, the viscosities of the gelled protein formulations of this patent disclosure will in most cases be brought to about 700 cps to about 1800 cps during an early stage of applicant's overall production processes. Those gelled protein formulations having viscosities of from about 900 cps to about 1500 cps are especially useful in making certain frozen forms of applicant's nutritional food products. That is to say that applicant has discovered that creation of certain gelled protein formulations near the beginning of a manufacturing process to produce a given product form (frozen, liquid, powdered, etc.) reduces the sensible off flavors otherwise associated with that product's protein ingredients. This finding is useful in its own right. It can also serve to reduce the amount of sweetener(s) and/or flavoring agents otherwise needed to mask those off flavors otherwise associated with applicant's protein ingredients.

These gelled protein formulations may, or may not, include other ingredients when the protein gel is created. That is to say that in some nutritional products of this patent disclosure, one or more other ingredients (e.g., sweeteners, stabilizers, vitamins, etc.) may be added to a gelled protein formulation after said gelled formulation attains a certain viscosity (e.g., 350 cps to 900 cps). The formulation may, or may not, be further gelled (e.g., to 700 cps to 1800 cps). In other nutritional products of this patent disclosure, an aqueous solution of one or more other ingredients (e.g., sweeteners, stabilizers, vitamins, etc.) is prepared and thereafter the protein-containing ingredients (e.g., whey, soy, egg white) are introduced into the aqueous solution of the other ingredient(s). The protein-containing ingredients then gel in the presence of the other ingredients. Here again, the resultant formulations will generally be brought to viscosities ranging from about 700 cps to about 1800 cps.

Sweeteners that might be employed in the practice of this invention can, for example, be natural sweeteners, and/or artificial sweeteners. Applicant's gelled protein formulations also may employ other ingredients such as micronutrients e.g., vitamins and minerals, amino acids, other protein-containing materials such as rice protein, oat protein and the like, essential and non-essential fatty acids, carbohydrates, dietary fibers, fiber derivatives, ribose, flavonoids, and/or their synthetic analogs. Moreover, applicant's gelled protein formulations may additionally be provided with one or more flavoring agents. The gelled protein formulations of this patent disclosure also may still further comprise other useful ingredients known to the food processing arts such as food stabilizers, food starches, coloring agents, emulsifiers and the like.

This invention also is based, at least in part, on applicant's further findings that the favorable palatable/organoleptic properties of these nutritional food products can be further enhanced if applicant's nutritional food products are prepared according to certain specific mixing methods hereinafter more fully described.

### DETAILED DESCRIPTION OF THE INVENTION

### Representative Gelled Protein Formulation Ingredients Whey Protein

Whey is the liquid remaining after milk has been curdled and strained e.g., as occurs in the production of cheese. Whey contains lactose, vitamins and minerals as well as traces of fat. The protein contained in whey is not a single protein but rather consists of a number of individual protein components such as: Beta-Lactoglobutin, Alpha-lactalbumin, Immunoglobulins, Bovine Serum Albumin (BSA), Glycomacropeptide (GMP), Lactoferrin, Lactoperoxidase and Lysozyme. Whey also has an excellent amino acid profile which includes Isoleucine, Leucine, Valine, Arginine, Lysine, Cysteine, Methionine, Glutamic Acid, Phenylalanine, Glycine, Threonine, Aspartic Acid, L-Tyrosine, Proline, Histidine, Serine, Alanine and Trytophan. Moreover, whey has a very high Biological Value (BV)—the rate at which the body can actually utilize a given substance. Whey is commercially available in several useful forms. For the purposes of this patent disclosure, the two most readily available and useful forms are whey protein isolate and whey protein concentrate. Whey protein isolate is the purest form of whey protein. It normally contains between about 90 to about 95% protein but little, if any, fat or lactose. Whey concentrate on the other hand does contain lactose, fat as well as certain minerals. Its protein content normally ranges from about 25 to 89% protein. Again however, whey, in either form, is not generally regarded by most human beings as having a pleasant taste.

### Soy Protein

The soybean plant is a legume. It is able to utilize the nitrogen of the air through the action of bacteria on its roots. Its seeds have a protein content of about 40%. Some soybean products (e.g., Archer Daniels Midland's NutriSoy® products) are processed from whole soybeans. Such processes leave the protein, okara, isoflavones, phytosterols, prebiotic sugars and oils of the soybean in the final powdered product. Such powdered products will generally have the following nutritional values:

| | Mg/100 g |
|---|---|
| MINERALS | |
| Potassium | 1600-2000 |
| Calcium | 150-300 |
| Phosphorus | 500-700 |
| Magnesium | 100-300 |
| Zinc | 2-4 |
| Iron | 7-10 |
| Manganese | 2-4 |
| Copper | 1-2 |
| VITAMINS | |
| Thiamin B1 | 0.65 |
| Riboflavin B2 | 0.30 |
| Niacin | 5 |
| Pantothenic acid | 2.5 |
| Folic Acid | 0.25 |

Other soybean products remove the soy seed's hulls and oil. After the hulls and the oil are removed, the remaining material will have a protein content of approximately 50%. These soy protein products fall into several commercially available categories that are generally based on their protein content. As was the case with whey, for the purposes of this patent disclosure, the two most readily available soy forms from which the hulls and oils are removed are soy protein concentrates and soy protein isolates. Soy protein concentrates are defatted flour from which sugar and water have been removed. They contain at least 65% protein on a moisture free basis. Soy protein isolates are defatted soy flour from which sugars and other water-soluble materials as well as cotyledon fibers have been removed as well. They normally contain more than 90% protein on a moisture free basis. The essential amino acids contained in soy proteins include: Histidic, Isoleucine, Leucine, Lysine, Methionine+cystine, Phenylalanine+tyrosine, Threonine, Trypotophan and Valine. And as with most other protein-containing nutritional food ingredients, soy protein, in any of its commonly available forms, is not generally regarded as having a pleasant taste to most humans.

### Egg Protein

The white, or albumen, makes up approximately two thirds of an egg's liquid weight and contains more than half the egg's total protein, niacin, riboflavin, chlorine, magnesium, potassium, sodium and sulfur. Egg white also contains very little carbohydrate and virtually no fat or cholesterol. It is also low in calories. Moreover, egg proteins also have a complete amino acid profile and a high biological value. Their powdered forms are not, however, known for their pleasant tastes.

### Sweeteners

As previously noted, use of applicant's gelled protein formulations in a nutritional food product produces tastes that are more palatable to a much broader group of consumers without the virtual necessity of using sweeteners. However, sweeteners do undeniably serve to further improve the palatable/organoleptic characteristics of all of applicant's products (be they powders, liquids, solids or frozen foods). Their use is therefore optional, but very useful, in the practice of this invention. A given choice of sweetener, and its relative concentration, is likely to be determined by the type and amount sweetness needed for satisfactory palatable/organoleptic properties in a particular kind of nutritional food product. For example, a powdered protein powder intended for use by diabetics may contain little or no sweetener. At the other end of applicant's sweetener use spectrum, a pleasure food product (such as a frozen pleasure food bar) will normally contain relatively large amounts of sweeteners.

In any case, the sweeteners that (optionally) can be used in all physical forms of applicant's products (e.g., powder, liquid, frozen product, etc.) can be natural sugars, as well as sugar substitutes. For example, such sugars can include, but are not limited to, cane sugar, corn syrup, corn syrup solids, dextrose, crystalline fructose, sucrose, maltodextrin, lactose, maltose, honey, rice syrup, grain syrup, polydextrose, ologodextrin, etc. Artificial sweeteners, sugar substitutes and non-nutritive sweeteners that can be used in the practice of this invention may include, but are not limited to, saccharin salts, aspartame, saccharine, cyclamates, steviosides, glycyrrhizins, sorbitol, xylitol, talin, cyclohexylsulfamates, aspartyl malonates, succanilic acids and amino acid based sweeteners. All such sweeteners may be incorporated into applicant's products in amounts such that they may constitute up to approximately 25 percent by weight of a final product.

For example, in some of applicant's frozen nutritional food products, the level of cane sugar therein may be as high as 25% by weight or as low as 1.0% by weight of the final frozen food product—especially if other sweeteners such as dextrose, corn syrup solids and the like are also present. In one particularly good tasting frozen food product produced by this invention, the level of cane sugar will be from about 14% to about 20% by weight when it is used in conjunction with a corn syrup solid ingredient used in a concentration such that it constitutes from about 0.5% to about 5.0% by weight and a dextrose ingredient used in concentrations such that it constitutes from about 0.5% to about 5.0% by weight of that final frozen food product. Indeed, some of applicant's frozen products, so sweetened, may even approach the demanding palatable/organoleptic properties expected of certain pleasure foods.

### Flavoring Agents

As used herein the term(s) “flavoring agent(s)” refers to compounds, other than sugars, that serve to impart distinctive flavors to applicant's final products. Use of such flavoring agents is optional to the practice of this invention. If used, such flavorings can be fruit or non-fruit flavoring agents (natural or synthetic). Examples of suitable natural flavorings include: (1) citrus and non-citrus fruit flavors (e.g., whole or comminuted fresh fruit, fruit purees, fruit concentrates, extracts or essences, candied or glazed fruits, and dried fruits), (2) chocolate, cocoa or chocolate liquor, (3) natural flavorings obtained from vanilla beans, (4) sugar-free versions of fruit flavorings, (5) flavors derived from botanicals, (6) spices, (7) coffee and (8) nutmeats and nut extracts from pecans, walnuts, almonds, pistachios, filberts and peanuts. Other examples of useful flavoring agents will include, but are not limited to, pure vanilla extract, strawberry extract, raspberry extract, cranberry extract, black cherry extract, anise extract, imitation banana extract, imitation cherry extract, chocolate extract, pure lemon extract, pure orange extract, pure peppermint extract, pineapple extract, imitation rum extract, or orange/pineapple formulations. Examples of non-natural or synthetically derived flavorings may also include aromatic chemicals and imitation flavors. The term “flavoring agent” for the purposes of this patent disclosure may also include: cookie crumbs, whole or comminuted food pieces, extracts, concentrates and essences derived from natural and/or synthetically produced sources. The particular amount of flavoring agent included in the nutritional food products of the present invention will depend upon the degree of flavor effects desired and the particular flavoring substance used. Usually, the flavoring agent will comprise from about 0.001% to about 2.0% by weight of a final product.

### Nutrient Ingredients

Nutrient ingredients that can (optionally) be included in applicant's gelled protein formulations may comprise micronutrients, macronutrients, concentrated food constituents, amino acids, digestive enzymes, flavonoids, isoflavones, carotenoids, beta glucans, choline, serine and nucleotides. Some particularly useful micronutrients that can be used in applicant's frozen food products will include vitamins A, C and E as well as vitamins B1, B2, B3, B6, B9 and B12. Other micronutrients may include, but not be limited to, calcium, magnesium, phosphorus, zinc, calcium phosphate or acetate, potassium chloride or acetate, ferric orthophosphate, zinc sulfate or oxide, copper gluconate, vitamin D3, copper sulfate, manganese, potassium, sodium, copper, iron, selenium, iodine, chromium, molybdenum, boron, vanadium and ascorbic acid. Usually, the flavoring agent(s) will comprise from about 0.01 to about 0.10 weight percent of a final product.

### Food Processing Additives

Applicant's nutritional food products, and especially the frozen nutritional food products, may further comprise other (optional) ingredients that serve to better process the other ingredients. For example, these food processing ingredients may include food stabilizers e.g., stabilizing gums, water-binding gums, gelling agents, and insoluble blocking agents. Those skilled in the food processing arts will appreciate that stabilizers can produce a smoothness in the textural properties of many products, retard or reduce ice crystal growth during storage of frozen products and provide uniformity and/or resistance to melting of a frozen product. Stabilizers typically function through their ability to form gel structures in water or their ability to combine with water by hydration. Such stabilizers can include, but not limited to, sodium alginate, propylene glycol alginate, calcium sulphate, gelatin, gum acacia, guar gum, gum karaya, locust bean gum, gum tragicanth, carrageenan, xanthan gum, as well as mixtures of these stabilizers. Useful gelling agents may include, but not be limited to, gelatin, xanthan gum, carrageenan, sodium alginate, and pectin. The amount of stabilizer and/or gelling agents included in a frozen food product of this patent disclosure may comprise up to about 2% by weight of a final frozen product.

In certain frozen nutrition food products, emulsifiers also may be added to the gelled protein formulation in order to promote inclusion of air during freezing, increased resistance to melting and increased dryness. Use of emulsifiers in concentrations that produce overruns of from about 50 to about 300 in certain frozen products of this patent disclosure may produce particularly appealing final products. Such emulsifiers can include, but not be limited to, mono- and diglycerides, distilled mono-glycerides and drying agents such as polysorbate 80, polysorbate 65, and ethoxylated mono- and diglycerides. If used, such emulsifiers will generally constitute up to about 0.2% by weight of the final frozen food product.

### Useful Protein Formulations

By way of more specific examples of this invention, applicant has found that very good taste results in frozen, solid, liquid and powdered final products can be obtained by first preparing an aqueous solution of various non-protein ingredients (e.g., sweeteners, stabilizers, nutrients, etc.) and then introducing the protein-containing ingredients into that aqueous solution. In such cases, the protein-containing ingredients may be used in concentrations such that they will fall within the following weight percentage ranges of a given final product, and especially a frozen nutritional food bar:

| Ingredient | weight % in final product |
|---|---|
| whey protein Isolate | 1-15.0 |
| whey protein concentrate | 0.5-10.0 |
| soy protein | 0.5-5.0 |
| egg protein (whites) | 0.5-5.0 |

In some of the more practically oriented manufacturing processes of this patent disclosure, the whey, soy and egg will be directly introduced into the aqueous solution in the flake or powdered forms in which they are most commonly commercially available. Other embodiments of this invention may involve the addition of protein-containing solutions to the aqueous solutions of the other ingredients. In either case, these protein-containing ingredients will then undergo a gelling reaction (induced by cooling) that takes the other ingredient/protein-containing formulation from a viscosity of about 350 cps to about 900 cps to a final viscosity of from about 700 cps to about 1800 cps. If the other ingredients include gellable materials (e.g., gellable stabilizers, starches, emulsifying agents, etc.) these other gellable materials may also enter into the gelling reactions along with the protein-containing ingredients. In either case, the viscosity of the resulting other ingredient/protein-containing formulation will normally be brought to final levels of about 700 cps to about 1800 cps.

By way of another specific example of this invention, applicant has found that protein formulations having the ingredients and concentrations percentage indicated above also will produce favorable palatable/organoleptic properties in a frozen, powdered, liquid or solid final product—if the protein-containing formulation is gelled to an extent such that its viscosity is increased from about 350 cps to about 900 cps before any additional ingredients (e.g., sweeteners, vitamins, stabilizers, etc.) are introduced into that gelled protein formulation. Thereafter the resulting formulation is brought to a viscosity of from about 700 cps to about 1800 cps. That is to say that, in either ingredient addition order (i.e., adding the protein-containing ingredients to an aqueous solution of other ingredients, or adding the other ingredients to a protein-containing aqueous solution), the resulting products will have improved flavor characteristics for having undergone applicant's protein gelling step.

Using either mixing method, such other ingredients in a frozen, liquid, solid or powdered final product may include, by way of example only, the following other ingredients (i.e., other than the protein-containing ingredients) used in the final product weight percentage ranges indicated:

| Ingredient | weight % in final product |
|---|---|
| Sugar (cane) | 14-25 |
| Corn syrup solid (CSS) having a | 0.5-4.0 |
| dextrose equivalent (DE) of about 36 | |
| Modified Food starch | 0-1.5 |
| Stabilizer | 0.15-1.0 |
| Dextrose | 1-5-5.0 |

In still other embodiments of this patent disclosure, an overall gellable protein/other ingredient formulation might further include the following ingredients used in concentrations such that they constitute the final product weight percentages indicated:

| Ingredient | weight % in final product |
|---|---|
| Litesse/Fibersol | 1-6.0 |
| Ca Citrate | 0-4.0 |

In yet another embodiment of this invention, such a formulation might further include coloring agents used in concentrations that produce the final product weight concentrations indicated:

| Ingredient | weight % in final product |
|---|---|
| 10/12 cocoa red | 0-4.0 |
| 10/12 cocoa black | 0-2.0 |
| 22/24 cocoa red | 0-2.0 |

In still other embodiments, a final product, in whatever physical form, might further comprise antioxidants used in concentrations such that they constitute the daily vitamin (% DV) requirements indicated:

| Antioxidant vitamins | % DV |
|---|---|
| A | 0.0-50.0 |
| C | 0.0-200.0 |
| E | 0.0-100.0 |

Similarly, a final product might further comprise vitamin B's used concentrations such that they give the final product the daily vitamin (% DV) requirements indicated:

| Vitamin B's | % DV |
|---|---|
| B1 | 10.0-100.0 |
| B2 | 10.0-100.0 |
| B3 | 10.0-100.0 |
| B6 | 10.0-100.0 |
| B9 | 10.0-100.0 |
| B12 | 10.0-100.0 |

Expressed as a weight percentage such antioxidant(s) and/or vitamin(s) may each comprise from about 0.01 to about 0.10 weight percent of a given final product.

### Representative Frozen Food Product

One particularly pleasant tasting frozen nutritional food product of this patent disclosure can be comprised of:

| | weight % in |
|---|---|
| Ingredient | final frozen product |
| whey protein Isolate flakes | 1-15.0 |
| soy protein (whole bean flakes) | 0.5-5.0 |
| egg protein (whites) flakes | 0.5-5.0 |
| Sugar (cane) | 14-25 |
| CSS (36 DE) | 0.5-4.0 |
| Modified Food starch | 0-1.5 |
| Stabilizer | 0.15-1.0 |
| Dextrose | 1-5.5 |
| Litesse/Fibersol | 1-6.0 |
| Ca Citrate | 0-4.0 |
| 10/12 cocoa red | 0-4.0 |
| 10/12 cocoa black | 0-2.0 |
| 22/24 cocoa red | 0-2.0 |
| Antioxidant vitamins (% DV) | |
| A | 0.0-50.0 |
| C | 0.0-200 |
| E | 0.0-100.0 |
| Vitamin B's (% DV) | |
| B1 | 10-100 |
| B2 | 10-100 |
| B3 | 10-100 |
| B6 | 10-100 |
| B9 | 10-100 |
| B12 | 10-100 |

Still other particularly pleasant tasting frozen nutritional food products of this patent disclosure are illustrated by the following Examples 1, 2 and 3, which in no way however should be construed as limiting the scope of this invention.

### EXAMPLE 1

Vanilla Flavored Frozen Food Product

| | wt. % in |
|---|---|
| Ingredient | final frozen product |
| Sugar | 16.0 |
| CSS (36 DE) | 2.0 |
| Polydextrose | 3.0 |
| Stabilizer | 0.2 |
| Calcium Citrate | 1.7 |
| WPI (whey protein isolate) | 3.0 |
| WPC 80 (whey protein concentrate 80) | 6.0 |
| Soybean powder | 0.5 |
| Egg whites | 0.5 |
| Dextrose | 1.5 |
| Mod Food Starch | 0.1 |
| Vitamin blend | 0.06 |
| Stabilizer | 0.25 |
| Vanilla flavor agent | 0.01 |

### EXAMPLE 2

Sorbet Mix for Outer Layer of a Two Layered Frozen Food Product Such as that Described in Example 1

| | wt. % in |
|---|---|
| Ingredient | final frozen product |
| Sugar | 23.25 |
| CSS | 3.0 |
| Stabilizer | 0.25 |
| Fruit | 15.0 |

### EXAMPLE 3

Chocolate Flavored Frozen Food Product

| | wt. % in |
|---|---|
| Ingredient | final frozen product |
| Sugar | 19.0 |
| CSS (36 DE) | 1.8 |
| Polydextrose | 3.0 |
| Stabilizer | 0.2 |
| Calcium Citrate | 1.5 |
| WPI | 6.0 |
| Soybean Powder | 0.5 |
| Egg Whites | 0.5 |
| Mod. Food Starch | 0.15 |
| 10/12 cocoa red | 1.5 |
| 22/24 cocoa | 2.0 |
| 10/12 cocoa black | 0.3 |
| Vitamin blend | 0.06 |
| Stabilizer | 0.2 |

All such frozen nutritional food products may further comprise a handle (e.g., a wooden handle) for conveniently holding the frozen nutritional food product while it is being eaten.

### Powdered Nutritional Food Products

By way of more specific examples of products covered by this invention, applicant has found that protein formulations having the following ingredients, used in the relative proportions indicated:

| Ingredient | relative wt % |
|---|---|
| whey protein Isolate flakes | 1-15.0 |
| whey protein concentrate flakes | 0.5-10.0 |
| soy protein (whole bean flakes) | 0.5-5.0 |
| egg protein (whites) flakes | 0.5-5.0 |

produce more favorable palatable/organoleptic properties in a powdered final product if these protein formulations are gelled to an extent that the viscosity of the protein formulation is increased from about 700 cps to about 1800 cps before said formulation is dried to a powdered form, or before it is used as an intermediate formulation, i.e., before introducing additional ingredients (e.g., sweeteners, vitamins, stabilizers, etc.) into the gelled formulation before it is dried and otherwise processed to create a resultant powdered material.

For example, such additional ingredients in such powdered nutritional food products may also include the following ingredients used in the relative weight concentrations indicated.

| Ingredient | relative wt % |
|---|---|
| Sugar (cane) | 14-25 |
| CSS (36 DE) | 0.5-4.0 |
| Mod Food starch | 0-1.5 |
| Stabilizer | 0.15-1.0 |
| Dextrose | 1-5.5 |

Still other powdered nutritional food products may further comprise certain other ingredients used in the relative weight concentrations indicated:

| Ingredient | relative wt % |
|---|---|
| Litesse/Fibersol | 1-6.0 |
| Ca Citrate | 0-4.0 |

In yet other embodiments, the powdered food products may further comprise antioxidants used in the concentrations indicated:

| Antioxidant vitamins | % DV |
|---|---|
| A | 0.0-50.0 |
| C | 0.0-200.0 |
| E | 0.0-100.0 |

In yet other powdered product embodiments, the overall formulation may further comprise certain vitamin B's used in the concentrations indicated:

| Vitamin B's | % DV |
|---|---|
| B1 | 10.0-100.0 |
| B2 | 10.0-100.0 |
| B3 | 10.0-100.0 |
| B6 | 10.0-100.0 |
| B9 | 10.0-100.0 |
| B12 | 10.0-100.0 |

### Liquid Food Products

By way of more specific examples covered by this invention, applicant has found that liquid protein formulations having the following ingredients, and used in the indicated proportions:

| | wt. % in |
|---|---|
| Ingredient | final liquid product |
| whey protein Isolate flakes | 1-15.0 |
| whey protein concentrate flakes | 0.5-10.0 |
| soy protein (whole bean flakes) | 0.5-5.0 |
| egg protein (whites) flakes | 0.5-5.0 |

will have more favorable palatable/organoleptic properties if its protein-containing ingredients have been gelled to an extent that the viscosity of the protein formulation is increased from about 700 cps to about 1800 cps before being placed in a drinkable liquid carrier such as water, fruit juices and the like. Such gelled formulations also can be used as an intermediate formulation, i.e., before introducing additional ingredients (e.g., sweeteners, vitamins, stabilizers, etc.) into the protein formulation in order to make a liquid nutritional drink.

For example, such additional ingredients may include the following ingredients used in the weight percentages indicated for a final liquid product:

| | wt. % in |
|---|---|
| Ingredient | final liquid product |
| Sugar (cane) | 14-25 |
| CSS (36 DE) | 0.5-4.0 |
| Mod Food starch | 0-1.5 |
| Stabilizer | 0.15-1.0 |
| Dextrose | 1-5.5 |

In still other embodiments, such liquid formulation might further comprise:

| | wt. % in |
|---|---|
| Ingredient | final liquid product |
| Litesse/Fibersol | 1-6.0 |
| Ca Citrate | 0-4.0 |

In yet other embodiments, the liquid might include coloring agents such as

| | wt. % in |
|---|---|
| Ingredient | final liquid product |
| 10/12 cocoa red | 0-4.0 |
| 10/12 cocoa black | 0-2.0 |
| 22/24 cocoa red | 0-2.0 |

In yet other embodiments, such a liquid formulation may further comprise antioxidants used in the % DV concentrations indicated:

| Antioxidant vitamins | % DV |
|---|---|
| A | 0.0-50.0 |
| C | 0.0-200.0 |
| E | 0.0-100.0 |

In yet other embodiments, such a liquid formulation may further comprise vitamin B's used in the % DV concentrations indicated:

| Vitamin B's | % DV |
|---|---|
| B1 | 10.0-100.0 |
| B2 | 10.0-100.0 |
| B3 | 10.0-100.0 |
| B6 | 10.0-100.0 |
| B9 | 10.0-100.0 |
| B12 | 10.0-100.0 |

Another particularly pleasant tasting liquid nutritional food product can be comprised of:

| Ingredient | wt % |
|---|---|
| whey protein Isolate flakes | 1-15.0 |
| whey protein concentrate flakes | 0.5-10.0 |
| soy protein (whole bean flakes) | 0.5-5.0 |
| egg protein (whites) flakes | 0.5-5.0 |
| Sugar (cane) | 14-25 |
| CSS (36 DE) | 0.5-4.0 |
| Mod Food starch | 0-1.5 |
| Stabilizer | 0.15-1.0 |
| Dextrose | 1-5.5 |
| Litesse/Fibersol | 1-6.0 |
| Ca Citrate | 0-4.0 |
| 10/12 cocoa red | 0-4.0 |
| 10/12 cocoa black | 0-2.0 |
| 22/24 cocoa red | 0-2.0 |

| | % DV |
|---|---|
| Antioxidant vitamins | |
| A | 0.0-50.0 |
| C | 0.0-200 |
| E | 0.0-100.0 |
| Vitamin B's | |
| B1 | 10-100 |
| B2 | 10-100 |
| B3 | 10-100 |
| B6 | 10-100 |
| B9 | 10-100 |
| B12 | 10-100 |

with the remainder being a drinkable fluid such as water, fruit juice and the like.

### Processing Steps

In one particularly effective embodiment of this invention, the protein-containing ingredients are added (e.g., in their powdered forms) to a heated (e.g., to a temperature from about 110° F. to about 130° F., and especially near about 120° F.) aqueous solution containing various other ingredients (e.g., sweeteners, stabilizers, vitamins, etc.). For certain frozen nutritional food products of this patent disclosure, a particularly effective order of incorporation is water, sugar, corn syrup solids, stabilizer, calcium, the protein-containing ingredients, and vitamins. The resulting formulation is then brought to a viscosity of from about 700 cps to about 1800 cps. This viscous formulation is then pasteurized using 170° to 190° F. and especially 180 F. temperatures for 20 to 40 seconds and especially for about 30 seconds. The resulting material can be homogenized (e.g., in two stages e.g., at 1500 and 500 psi) before and/or after being pasteurized. The entire formulation, or a portion of it, may then be sent to a flavor tank where one or more flavor(s) may be mixed into the formulation. When the pasteurizer is of the batch type, homogenization normally will follow immediately afterwards. In continuous flow systems, however, homogenization may be required prior to pasteurization. Other pasteurization methods may employ shorter processing times and higher processing temperatures. That is to say that many embodiments of this invention may be based on adding a flavoring agent after the gelling step has been completed. In other embodiments some flavoring agents will be added to a formulation before, or while, said formulation is undergoing its gelling reaction.

After pasteurization and homogenization, a formulation destined to create a frozen nutritional food product is then cooled to from about 45° F. to about 35° F. (and especially nearer about 40° F. or less) and thereafter stored in a holding tank at the 40° F. temperature for anywhere between about 0.1 hours and about 72 hours. The resulting cooled materials are then quiescently frozen in stainless steel molds submerged in brine solutions below −10 F.

A dual textured vanilla sorbet product made according to the teachings of this patent disclosure can be assembled in the following fashion: 1) a fruit sorbet mix is injected into a stainless steel mold and allowed to partially freeze, 2) a center core of the fruit sorbet mix is vacuum evaporated, 3) the center core is replaced with a protein mix that is injected into the cavity, 4) a stick is then inserted into the partially frozen product and (5) the resulting frozen dual textured product is then picked out of the mold.

While applicant's invention has been described with respect to use of various kinds of protein-containing nutritional foods, as well as other ingredients, the spirit of this invention is to gel a given formulation's protein-containing ingredients in an early stage of the nutritional food's production process. This invention is therefore limited only by the scope of the following claims.

What is claimed is:

1. A nutritional food product derived from a gelled formulation comprising from about 1.0 to about 20.0 relative weight percent whey protein, from about 0.5 to about 5.0 relative weight percent soy protein, and from about 0.5 to about 5.0 relative weight percent egg protein.

2. The nutritional food product of claim 1 wherein the gelled formulation had a viscosity of from about 700 cps to about 1800 cps during an early stage of its production process.

3. The nutritional food product of claim 1 that further comprises a sweetener.

4. The nutritional food product of claim 1 that further comprises an antioxidant.

5. The nutritional food product of claim 1 that further comprises a nutrient.

6. The nutritional food product of claim 1 that further comprises a flavoring agent.

7. The nutritional food product of claim 1 wherein said product has a final form selected from the group of final forms consisting of a frozen nutritional food product, a liquid nutritional food product, a solid nutritional food product or a powdered nutritional food product.

8. A frozen nutritional food product derived from a gelled formulation comprising whey protein, soy protein and egg protein in concentrations such that the frozen nutritional food product will comprise from about 1.0 to about 20.0 relative weight percent whey protein, from about 0.5 to about 5.0 relative weight percent soy protein, and from about 0.5 to about 5.0 relative weight percent egg protein.

9. The nutritional food product of claim 8 wherein the gelled formulation had a viscosity of from about 700 cps to about 1800 cps during an early stage of its production process.

10. The frozen nutritional food product of claim 8 that further comprises from about 14.0 to about 25.0 weight percent sugar.

11. The frozen nutritional food product of claim 8 that further comprises from about 0.5 to about 5.0 weight percent corn syrup solid.

12. The frozen nutritional food product of claim 8 that further comprises from about 1.0 to about 5.0 weight percent dextrose.

13. The frozen nutritional food product of claim 8 that further comprises from about 0.01 to about 1.5 weight percent food starch.

14. The frozen nutritional food product of claim 8 that further comprises from about 0.15 to about 1.0 weight percent stabilizer.

15. The frozen nutritional food product of claim 8 that further comprises from about 1.0 to about 6.0 weight percent litesse/fibersol.

16. The frozen nutritional food product of claim 8 further comprises from about 0.01 to about 4.0 weight percent calcium citrate.

17. The frozen nutritional food product of claim 8 that further comprises from about 0.01 to about 4.0 weight percent of a coloring agent.

18. The frozen nutritional food product of claim 8 that further comprises an antioxidant selected from the group consisting of antioxidant A, antioxidant C and antioxidant E.

19. The frozen nutritional food product of claim 8 that further comprises a vitamin selected from the group consisting of vitamin B1, vitamin B2, vitamin B3, vitamin B6, vitamin B9 and vitamin B12.

20. The frozen nutritional food product of claim 8 that further comprises an outer layer of sorbet.

21. The frozen nutritional food product of claim 8 that further comprises an outer layer of sorbet comprising sugar, corn syrup solids, stabilizer and fruit.

22. The frozen nutritional food product of claim 8 further comprising a handle.

23. A vanilla flavored frozen product comprising the following ingredients in the weight percentages indicated: sugar (16.0%), corn syrup solids (2.0%), polydextrose (3.0%), stabilizer (0.2%), calcium citrate (1.7%), whey protein isolate (3.0%), whey protein concentrate 80 (6.0%), soybean powder (0.5%), egg white protein (0.5%), dextrose (1.5%), modified food starch (0.1%), vitamin blend (0.06%), stabilizer (0.25%) wherein said ingredients were gelled to a viscosity of from about 700 cps to about 1800 cps during an early stage of the product's production process.

24. The vanilla flavored frozen food product of claim 23 that further comprises a sorbet mix used as an outer layer of a two layered frozen food product and wherein the sorbet mix is comprised of the following ingredients in the weight percentages indicated: sugar (23.25%), corn syrup solids (3.0%), stabilizer (0.25%) and fruit (15%).

25. A chocolate flavored frozen food product comprising the following ingredients in the weight percentages indicated: sugar (19.0%), corn syrup solids (1.8%), polydextrose (3.0%), stabilizer (0.2%), calcium citrate (1.5%), whey protein isolate (6.0%), soybean powder (0.%5), egg white protein (0.5%), modified food starch (0.15%), 10/12 cocoa red (1.5%), 22/24 cocoa (2.0%), 10/12 cocoa black (0.3%), vitamin blend (0.06%) and stabilizer (0.2%) wherein said ingredients were gelled to a viscosity of from about 700 cps to about 1800 cps during an early stage of the product's production process.

26. A method for producing a nutritional food product comprising:
(1) heating water to a temperature of from about 110 degrees F. to about 130 degrees F.;
(2) adding at least one sweetener to the heated water in an amount such that said sweetener will constitute from about 1.0 to about 25.0 weight percent of the nutritional food product;
(3) adding at least one food processing additive to the heated water in an amount such that said food processing additive will constitute from about 0.1 to about 2.0 weight percent of the nutritional food product;
(4) adding at least one nutrient to the heated water in an amount such that said nutrient will constitute from about 0.01 to about 0.10 weight percent of the nutritional food product;
(5) adding a whey protein to the heated water in an amount such that said whey protein will constitute from about 1.0 to about 30.0 weight percent of the nutritional food product;
(6) adding a soy protein to the heated water in an amount such that said soy protein will constitute from about 0.5 to about 5.0 weight percent of the nutritional food product;
(7) adding an egg protein to the heated water in an amount such that said egg protein will constitute from about 0.5 to about 5.0 weight percent of the nutritional food product;
(8) gelling a resulting heated water/whey protein/soy protein/egg protein formulation to an extent such that the viscosity of said formulation is raised to from about 700 cps to about 1800 cps; and
(9) converting the gelled formulation into a nutritional food product.

27. The method of claim 26 wherein the gelled formulation is converted to a nutritional food product selected from the group of nutritional products consisting of a frozen nutritional food product, a liquid nutritional food product, a solid nutritional food product or a powdered nutritional food product.

28. A method for producing a nutritional food product comprising:
(1) heating water to a temperature from about 110 degrees F. to about 130 degrees F.;
(2) adding a whey protein to the heated water in an amount such that said whey protein will constitute from about 1.0 to about 30.0 weight percent of the nutritional food product;
(3) adding a soy protein to the heated water in an amount such that said soy protein will constitute from about 0.5 to about 5.0 weight percent of the nutritional food product;
(4) adding an egg protein to the heated water in an amount such that said egg protein will constitute from about 0.5 to about 5.0 weight percent of the nutritional food product;
(5) adding at least one sweetener to the heated water in an amount such that said sweetener will constitute from about 1.0 to about 25.0 weight percent of the nutritional food product;
(6) adding at least one food processing additive to the heated water in an amount such that said food processing additive will constitute from about 0.1 to about 2.0 weight percent of the nutritional food product;
(7) adding at least one nutrient to the heated water in an amount such that said nutrient will constitute from about 0.01 to about 0.10 weight percent of the nutritional food product;
(8) gelling a resulting water/whey protein/soy protein/egg protein/sweetener/food processing additive/nutrient formulation to an extent such that the viscosity of said formulation is raised to from about 700 cps to about 1800 cps; and
(9) converting the gelled formulation into a nutritional food product.

29. The method of claim 28 wherein the gelled formulation is converted to a nutritional food product selected from the group of nutritional products consisting of a frozen nutritional food product, a liquid nutritional food product, a solid nutritional food product or a powdered nutritional food product.

30. A method for producing a frozen nutritional food product comprising:
(1) heating water to a temperature of from about 110 degrees F. to about 130 degrees F.;
(2) adding at least one sweetener to the heated water in an amount such that said sweetener will constitute from about 1.0 to about 25.0 weight percent of the frozen nutritional food product;
(3) adding at least one food processing additive to the heated water in an amount such that said food processing additive will constitute from about 0.1 to about 2.0 weight percent of the frozen nutritional food product;
(4) adding at least one nutrient to the heated water in an amount such that said nutrient will constitute from about 0.01 to about 0.10 weight percent of the frozen nutritional food product;
(5) adding a whey protein to the heated water in an amount such that said whey protein will constitute from about 1.0 to about 15.0 weight percent of the frozen nutritional food product;
(6) adding a soy protein to the heated water in an amount such that said soy protein will constitute from about 0.5 to about 5.0 weight percent of the frozen nutritional food product;
(7) adding an egg protein to the heated water in an amount such that said egg protein will constitute from about 0.5 to about 5.0 weight percent of the frozen nutritional food product;
(8) gelling a resulting water/sweetener/whey protein/soy protein/egg protein/sweetener/food processing additive/nutrient formulation to an extent such that the viscosity of said formulation is raised to from about 700 cps to about 800 cps;
(9) pasteurizing the gelled water/sweetener/whey protein/soy protein/egg protein/sweetener/food processing additive, nutrient formulation;
(10) cooling the pasteurized formulation to a temperature of from about 35 degrees F. to about 45 degrees F. for from about 0.1 hours to about 72 hours; and
(11) freezing the cooled formulation to produce a frozen nutritional food product.

31. The method of claim 30 wherein the pasteurizing comprises: heating the water/sweetener/whey protein, soy protein, egg protein formulation to a temperature between about 170 degrees F. and about 190 degrees F. with a hold time of about 20 seconds to about 40 seconds.

32. The method of claim 30 further comprising a homogenizing step having: a first stage performed at about 1500 psi; and a second performed at about 500 psi.

33. The method of claim 30 further comprising an aerating step to produce an overrun of about 200%.
